(19) United States
(12) Patent Application Publication
(10) Pub. No.: US 2016/0233481 A1
(43) Pub. Date: Aug. 11, 2016

(54) ANTI-EXPLOSION PROTECTION MECHANISM AGAINST BATTERY OVERHEATING

(71) Applicant: Solomon CHANG, Keelung City (TW)

(72) Inventor: Solomon CHANG, Keelung City (TW)

(21) Appl. No.: 14/857,230

(22) Filed: Sep. 17, 2015

(30) Foreign Application Priority Data
Feb. 11, 2015 (CN) 201520096800.8

(51) Int. Cl. H01M 2/34

(52) U.S. Cl. CPC H01M 2/348; H01M 2220/30; H01M 2220/20; H01M 2200/10

(57) ABSTRACT

The present invention provides an anti-explosion mechanism against battery overheating. The power module includes one or a plurality of battery cells, a circuit board, a control device and one or a plurality of temperature sensors connected to one another. The anti-explosion mechanism against battery overheating is characterized that, the battery cell is provided with a temperature sensor and is connected to the control device. When the operating temperature of the battery cell reaches a predetermined temperature, such information is transmitted to the control device to perform a power interruption operation. Thus, the life cycle of a battery is protected, and anti-explosion and anti-fire effects are provided, thereby achieving reminding and protection effects in the application of the battery.

### BACKGROUND OF THE INVENTION

a) Field of the Invention

The invention relates in general to an anti-explosion protection mechanism against battery overheating, and more particular to an anti-explosion protection mechanism against battery overheating capable of quickly and easily interrupting a power supply.

b) Description of the Prior Art

In the recent years, with the continual progress in information technologies combined with applications of networks, mobile devices such as smart phones and tablet computers have become more and more popular. When a mobile device is used over an extended period of time, the power consumption is quickly increased. To satisfy power consumption needs of mobile devices, mobile power storage devices are currently commercially available. These mobile power storage devices readily and quickly provide power to various mobile devices to satisfy electric charging requirements at all times.

However, when an external battery power source is applied for long-term use, an issue of overheating is likely caused, leading to a shortened life cycle or even fires and explosions in more severe cases. The China Utility Model Application No. 201220738047.4, Publication No. CN203078324U discloses “Safety Device for Motorized Vehicle Battery Pack” discloses a battery pack including a management controller, a relay, a temperature sensor, a smoke detector and an alarm connected to one another. The status of the battery can be monitored when power is outputted. For example, in the event of overheating and smoke, a warning sound for alert can be immediately produced, so as to ensure that a user is informed in real-time to react to such emergency.

However, through a warning sound that is issued only when abnormal situations of smoke and overheating of the battery have already occurred, the protection for a user may be limited. Moreover, it remains questionable whether a user is capable of immediately and quickly separating the battery. Therefore, the above method still exposes a user to life-threatening hazards.

Therefore, in order to solve the issues of the above conventional structure, how to develop an innovative and ideal structure for practicability for consumers is a common goal and direction of related industrialists.

In view of the above, based years of manufacturing, development and design experiences of related products, the Applicant provides a practical invention after thorough design and evaluation to achieve the above object.

### SUMMARY OF THE INVENTION

It is a primary object of the present invention to provide an anti-explosion protection mechanism against battery overheating to solve the above issues. In a conventional battery safety device, the temperature and smoke are monitored and an instruction is sent to a management controller in case of an abnormal event. Meanwhile, an alarm sends a warning signal to prompt a user to react appropriately to prevent dangers. However, with the method of prompting a user by a warning sound, if the user is not located next to the machine and does not hear the warning sound to react appropriately and immediately, life threats upon neighboring households may be caused.

In a technical characteristic for solving the above issues, a power module is used as a mobile device for recharging. The power module includes one or a plurality of battery cells, a circuit board, a control device, and one or a plurality of temperature sensors. The power module is characterized that, the battery cell is provided with a temperature sensor and is connected to the control device. When an operating temperature of the battery cell reaches a predetermined standard, such message is transmitted to the control device through the temperature sensor to interrupt the operating power. Thus, the life cycle of the battery is protected, and anti-explosion and anti-fire effects are provided, thereby achieving disconnection and protection in the application of the battery.

It is secondary object of the present invention to provide the control device further comprising a power interrupting device, a display device, a restoration switch device and a different digital PCB (Printed Circuit Board) control device. Through the control device, configuration, display and reactivation of the temperature sensors may be performed.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a schematic diagram of recharging corresponding to a power module of an anti-explosion protection mechanism against battery overheating of the present invention;

FIG. 2 is a schematic diagram of a control device of an anti-explosion protection mechanism against battery overheating of the present invention; and

FIG. 3 is a schematic diagram of an assembly of a battery cell and a temperature sensor of an anti-explosion protection mechanism against battery overheating of the present invention.

### DETAILED DESCRIPTION OF THE PREFERRED EMBODIMENTS

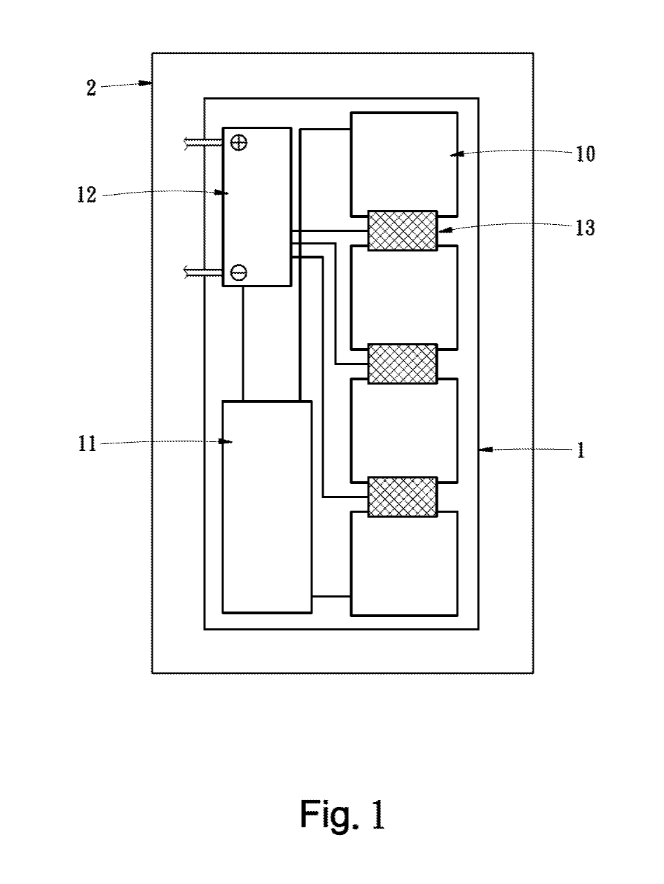

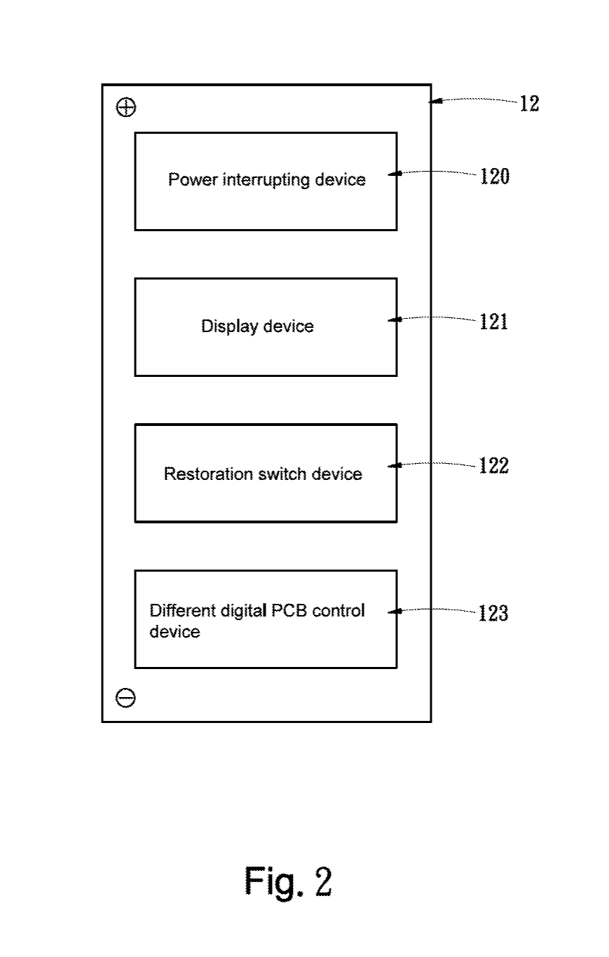

Referring to FIG. 1 and FIG. 2, a power module 1 of the present invention includes one or a plurality of battery cells 10, a circuit board 11, a control device 12, and one or a plurality of temperature sensors 13. The battery cells 10 may be one or more battery cells connected in series, and are connected to the circuit board 11. One temperature sensor 13 is disposed at each or between more than one battery cells 10, and is connected to the control device 12. Thus, the temperature sensor 13 detects whether the temperature of the battery cell 10 is too high to transmit a signal to the control device 12 to further perform an interruption operation.

The circuit board 11 is connected to the battery cells 10 and the control device 12, and provides a transmission path among the elements.

The control device 12, connected to the circuit board 11 and the temperature sensors 13, includes a power interrupting device 120, a display device 121, a restoration switch device 122 and a different digital PCB (Printed Circuit Board) control device 123. By connecting to the circuit board 11 and the temperature sensors 13, the control device 12 may interrupt the power supply according to a heat abnormal signal outputted from the temperature sensor 13, inspect power supply related information through the display device 121, and reactivate the power output supply through the restoration switch device 122 after the power supply has been interrupted. The different digital PCB control device 123 provides integration of a digital control power converter and circuits operating at different potentials to maintain voltage stability.

The temperature sensor 13 monitors for abnormal temperatures, and is disposed at one or between more than one battery cells 10. When an abnormal temperature occurs in one or more than one battery cells 10 connected in series, an abnormality signal is transmitted to the control device 12 and power is immediately interrupted to disconnect operations, thereby protecting the power module 1 from damages.

Thus, when the power module 1 charges the mobile device 2 through the control device 12, with monitoring and operations through the temperature sensor 13 and the control device 12, the power module 1 can be protected to have a prolonged life cycle, and explosion and fire hazards produced by overheating can be prevented, thereby achieving application disconnection and protection.

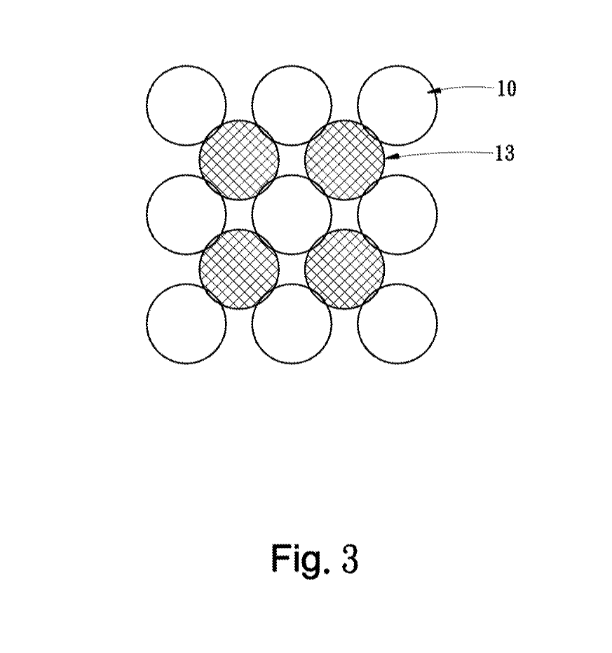

FIG. 3 shows a schematic diagram of the connection between battery cells 10 and temperature sensors 13 according to an embodiment of the present invention. As shown in FIG. 3, the battery cell 10 may be in a singular or plural quantity connected to one another, and the arrangement and type of the battery cell 10 are not limited. According to a combination configuration of the battery cell 10, one or more than one temperature sensors 13 are disposed therebetween. Thus, the temperature of the battery cell 10 in different combination configurations can be monitored to prevent disasters caused by a high temperature.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An anti-explosion protection mechanism against battery overheating, comprising a power module with one or a plurality of battery cells, a circuit board, a control device and one or a plurality of temperature sensors, wherein,
the battery cell is provided with one temperature sensor and connected to the control device; information of a temperature of one of the battery cells reaches a predetermined standard is transmitted to the control device to perform a power interruption operation, thereby protecting a life cycle of a battery and providing anti-explosion and anti-fire effects to achieve reminding and protection effects against overheating in an application of the battery.

2. The anti-explosion protection mechanism against battery overheating according to claim 1, wherein the control device is further provided with comprising a power interruption device, a display device, a restoration switch device and a different digital PCB (Printed Circuit Board) control device.

3. The anti-explosion protection mechanism against battery overheating according to claim 1, wherein the battery cell includes one battery cell or a plurality of battery cells connected in series.

4. The anti-explosion protection mechanism against battery overheating according to claim 1, wherein the temperature sensor includes one temperature sensor or a plurality of sensors connected to the battery cell.
